(19) United States
(12) Patent Application Publication
(10) Pub. No.: US 2012/0312788 A1
(43) Pub. Date: Dec. 13, 2012

(54) LASER MACHINING EQUIPMENT HAVING A COMMON GAS SOURCE FOR THE LASER OSCILLATOR AND HEAD

(75) Inventors: Christophe Bertez, Vaureal (FR); Olivier Matile, La Garenne Colombes (FR); Frédéric Neeb, Eragny Sur Oise (FR)

(73) Assignee: L'Air Liquide Societe Anonyme Pour L'Etude Et L'Exploitation Des Procedes Georges Claude, Paris (FR)

(21) Appl. No.: 13/579,322

(22) PCT Filed: Jan. 21, 2011
(86) PCT No.: PCT/FR2011/050113

§ 371 Date: Aug. 16, 2012

(30) Foreign Application Priority Data
Feb. 16, 2010 (FR) 1051067

(51) Int. Cl. B23K 26/12

(52) U.S. Cl. 219/74

(57) ABSTRACT

The invention relates to a laser machining equipment including a laser oscillator (1) for generating a laser beam, a laser head (3) through which the laser beam passes, an optical path (2) for conveying the laser beam between the laser oscillator (1) and the laser head (3), and a gas source (9) fluidly connected to the laser head (3) via a main gas pipe (8). In addition, a second pipe (18) fluidly connects the gas source (9) to the laser oscillator (1). The equipment therefore comprises a common gas source for the laser oscillator (1) and head (3). The gas is preferably nitrogen.

The invention relates to the field of welding, cutting or the like with a laser beam and, more precisely, to laser machining equipment with a laser oscillator, optical path and laser head supplied from the same gas source, in particular a nitrogen source.

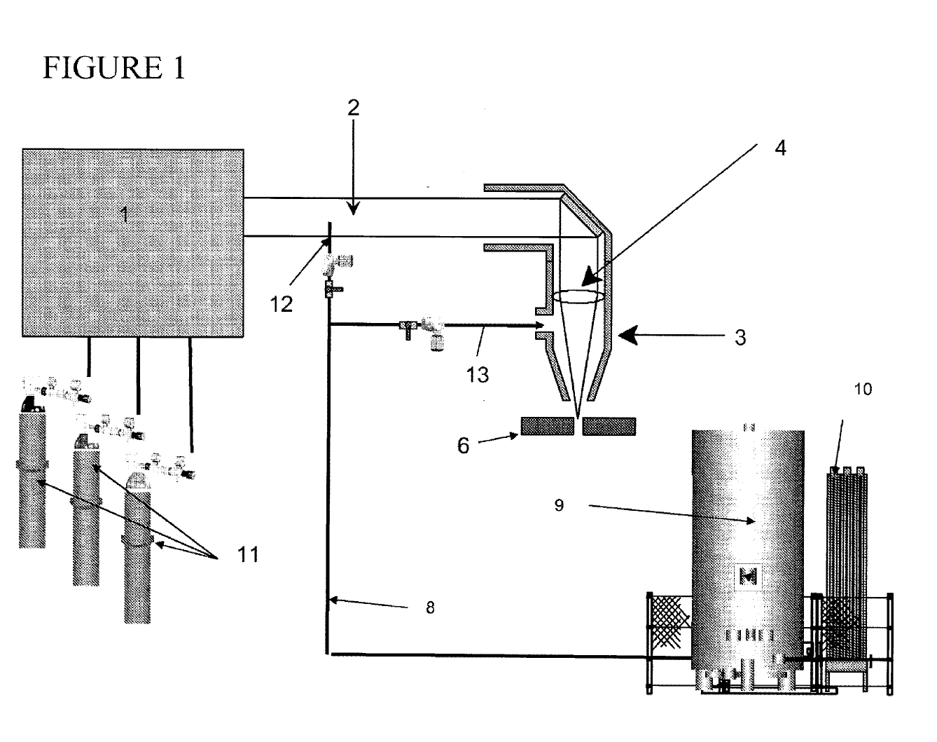

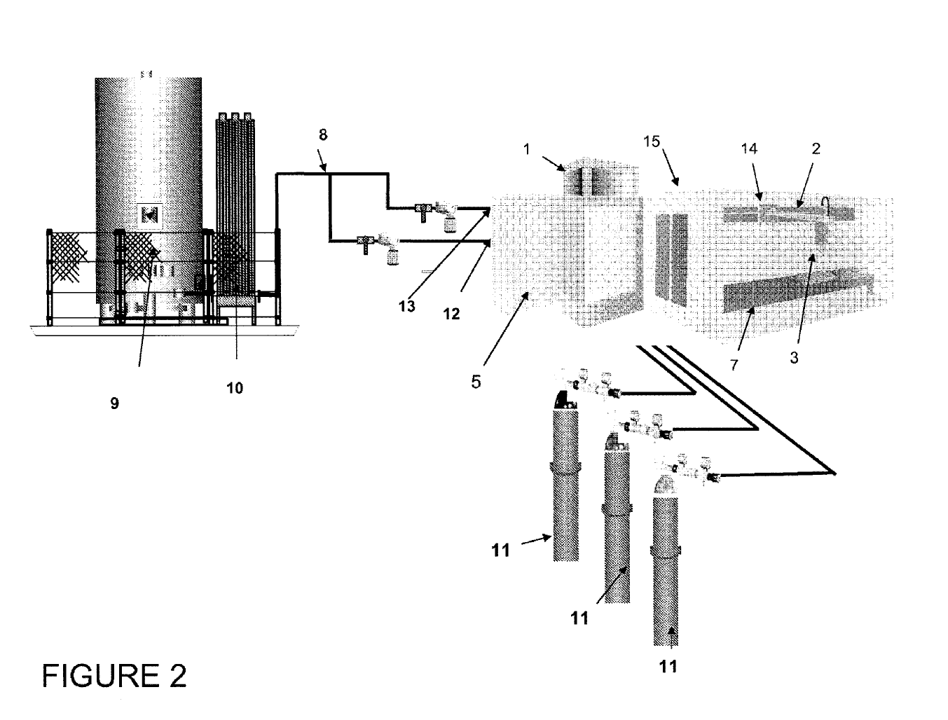

As illustrated in FIGS. 1 and 2, during the operation of a laser machine of the CO₂ type, that is to say with a laser oscillator 1 generating the laser beam, an optical path or cavity 2 transporting the beam and a laser head 3 focusing the beam onto the part or parts, the gas supply is carried out in two ways, namely:
on the one hand, the so-called “process” gas or gases which are used in laser cutting, for example nitrogen, oxygen or mixtures thereof, or in laser welding, such as argon, helium, nitrogen or mixtures thereof, usually come from a source or supply of the “bulk” type, that is to say a storage reservoir 9 of large capacity, or of the container type, that is to say gas-holding containers of limited capacity, typically gas cylinders. These “process” gases supply principally the focusing head, but possibly also the optical path of the laser. It should, however, be noted that the optical path may also be supplied with compressed air. Document US-A-2006/088073 teaches laser equipment of this type.
on the other hand, the so-called “lasing” gases, such as nitrogen, which supply the oscillator 1 of the laser device and which are therefore used for generating the laser beam, always come from a supply or source of the container type, that is to say gas cylinders 11, because the lasing gases must have very high purities, namely generally at least 99.999% by volume. Document U.S. Pat. No. 6,215,808 teaches laser equipment of this type with a plurality of oscillators.

The problem which arises on the industrial scale is that currently, when the gas used as process gas and lasing gas is of the same type, for example nitrogen, two separate supplies of the same gas are used, as schematized in FIGS. 1 and 2, in order to satisfy certain purity specifications, namely one supply necessarily of the “container” type for the lasing gas and another supply of the “bulk” type for the process gas.

This, however, leads to greater complexity of the laser equipment and therefore a direct extra cost and a loss of operating time for the user. Furthermore, it also makes it necessary to provide dedicated gas cylinders which are immobilized on site and are used only for supplying the laser oscillator 1.

It is an object of the present invention to provide a solution to this problem.

More precisely, the invention relates to laser machining equipment comprising a laser oscillator for generating a laser beam, a laser head through which the laser beam passes, an optical path for transporting the laser beam between the laser oscillator and the laser head, and a gas source fluidically connected to the laser head by means of a main gas pipe, characterized in that it furthermore comprises a secondary pipe fluidically connecting said gas source to the laser oscillator.

In other words, according to the present invention, a common gas source of large capacity, such as a reservoir for storing gas in gaseous or liquid form, supplies both the laser head used for the machining and the laser oscillator used for generating the laser beam.

It should be emphasized that “laser machining” is intended to mean an operation of welding, cutting, marking or any other work using a laser beam.

Depending on the case, the equipment of the invention may have one or more of the following characteristics:
the gas source is a storage reservoir having a capacity of at least 900 liters, advantageously at least 3000 liters, preferably at least 7500 liters.
it comprises a gas expansion device which is arranged along the secondary pipe and makes it possible to reduce the pressure of the gas coming from the gas source before it is introduced into the oscillator.
the gas source is a liquid nitrogen storage reservoir.
the gas source is fluidically connected to the laser head and to the optical path by means of the main pipe.
it comprises a gas vaporizer arranged between the gas source and the main pipe or the secondary pipe. In other words a heat exchanger, also called a vaporizer, is arranged at the reservoir outlet and makes it possible to vaporize the liquid nitrogen coming from the reservoir, and thus to obtain gaseous nitrogen which is subsequently conveyed in the main and secondary pipes.
a gas purification device, which comprises a filter or an adsorbent which is capable of and designed for removing at least one impurity selected from among water vapor, hydrocarbons and oxygen, is arranged along the secondary pipe and/or along the main pipe. Such a device may fulfill the function of a safety device making it possible to ensure that the purity of the gas is always complied with.
the oscillator is furthermore supplied with at least CO₂ and helium or a CO₂/He mixture coming from one or more gas cylinders.
the laser oscillator is of the CO₂ type.
the laser oscillator, the optical path and the laser head are located inside a building, and the gas source is located outside said building.

The invention also relates to a method for supplying laser machining equipment, comprising a laser oscillator, a laser head, and an optical path for transporting the laser beam between the laser oscillator and the laser head, with a gas coming from a gas source, in which:
a) some of the gas coming from the gas source is conveyed in a main pipe connecting said gas source to said laser head and in a secondary pipe connecting the gas source to the oscillator, and
b) said laser head is supplied with gas coming from said main pipe,

characterized in that the oscillator is supplied with gas coming from said secondary pipe.

Depending on the case, the method of the invention may have one or more of the following characteristics:
gas from the main pipe is introduced into the optical path.
the gas is nitrogen, preferably stored in liquid form.
the pressure of the gas is adjusted before it is introduced into the optical path, the oscillator and/or the laser head, or into the optical path. In particular, the pressure of the gas is reduced before it is introduced into the oscillator or the optical path.
the gas source is a storage reservoir having a capacity of at least 900 liters, preferably at least 3000 liters.
the oscillator is furthermore supplied with helium and CO₂ or a CO₂/He mixture coming from one or more gas cylinders.
at least some of the impurities of the oxygen, hydrocarbons and water vapor type, liable to be present in the gas, are removed so as to ensure a high purity of the gas introduced into the oscillator, in particular.
the nitrogen introduced into the oscillator has a purity of at least 99.999% by volume.
the nitrogen is drawn from the gas source in liquid form, then vaporized.

The invention will now be understood more clearly from the following description of an embodiment provided with reference to the appended figures, in which:

FIGS. 1 and 2 schematize laser equipment of the CO₂ type according to the prior art, and

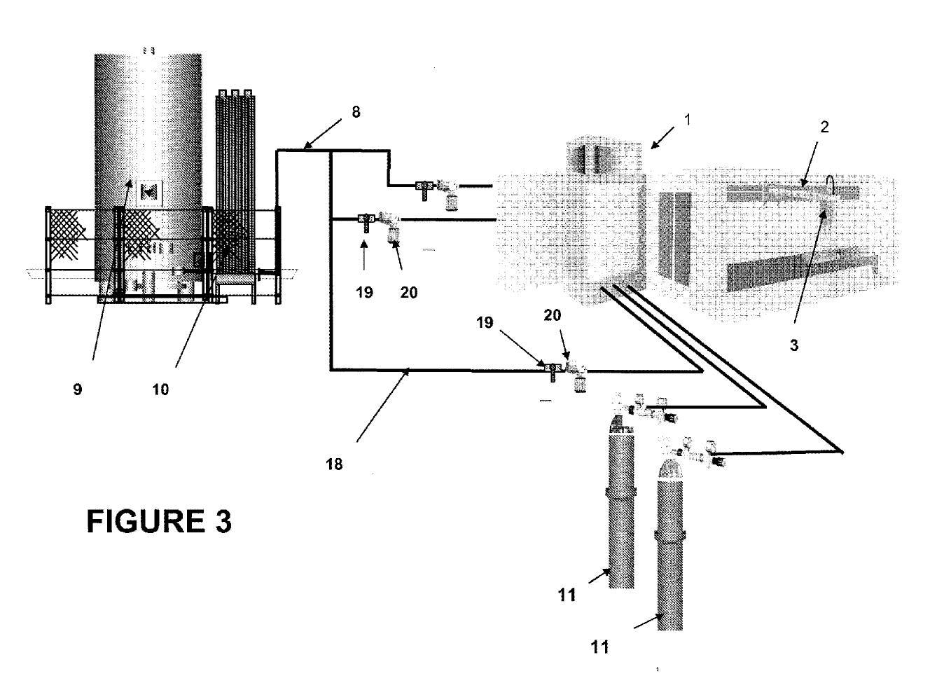

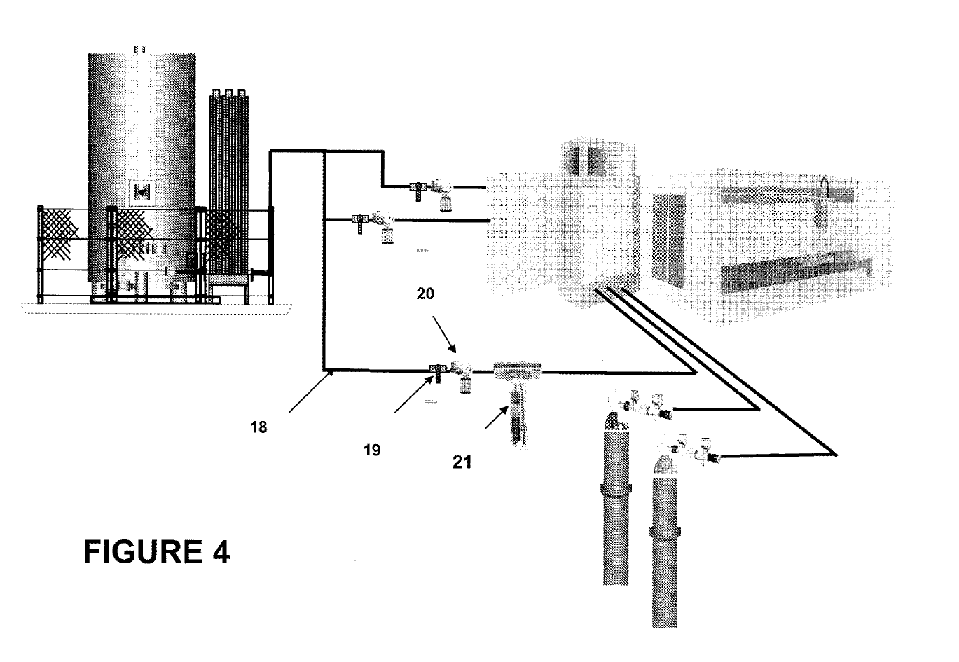

FIGS. 3 and 4 schematize laser equipment according to the invention.

FIGS. 1 and 2 represent a diagram of equipment for working using a laser beam of the CO₂ type, for example for laser cutting or laser welding, according to the prior art.

As can be seen, a laser generator or oscillator 1 of the CO₂ type makes it possible to generate a laser beam which is subsequently conveyed through an optical path or cavity 2 to a laser head 3, where it is focused by a focusing lens 4 or focusing mirror (in laser welding, a mirror has the purpose of directing and focusing the lens) or the like into the thickness or into the proximity of the surface of one or more parts 6 to be machined. For the sake of simplicity, it will be assumed below that the optical focusing device is a lens 4.

The lens 4 may have a single focus, i.e. a monofocal lens, or it may be multifocal, for example bifocal, that is to say focusing the beam onto two different focal points.

The lens 4 makes it possible to isolate the optical path 2 mechanically and fluidically from the laser head 3, because the pressures prevailing therein are not in general identical.

The laser oscillator 1 is supplied by 3 cylinders 11 of lasing gas, for example nitrogen of the LASAL™ brand 1, carbon dioxide (CO₂) of the LASAL™ brand 2 and helium of the LASAL™ brand 4; the gases of the LASAL™ brand are marketed by L'Air Liquide. In some cases, the oscillator may also be supplied with a gaseous premix containing nitrogen (N₂), helium and CO₂, or other constituents such as CO.

Furthermore, a nitrogen storage reservoir 9 of the “bulk” type, the outlet of which is fluidically connected to a vaporizer or heat exchanger 10, makes it possible to supply the laser head 3 and the optical path 2 with gaseous nitrogen via one or more gas pipes 8 and dedicated inlets 13, 12, respectively. The inlets 13, 12 are generally located at a gas supply cabinet 5, as illustrated in FIG. 2.

As can be seen in FIG. 2, the laser head 3 is normally carried by a bar 14 which can move relative to a machining table 1 on which the part or parts to be machined is/are arranged, all these being arranged in a protective enclosure 15.

This type of conventional equipment raises the problem of its complexity in the gas supplies.

The invention proposes to simplify the architecture of the equipment of FIGS. 1 and 2 in the manner illustrated in FIGS. 3 and 4. It should be pointed out that those parts of the equipment which are not modified will not necessarily be described below, and for all details regarding them reference will be made to FIGS. 1 and 2 and to the explanations given above.

As illustrated in FIG. 3, the generator or laser oscillator 1 of the CO₂ type, commonly referred to as a CO₂ laser source, which is used to generate the laser beam by using pressurized lasing gases, namely nitrogen, helium and CO₂, is supplied according to the invention with nitrogen coming no longer from a lasing gas cylinder 11 as seen in FIGS. 1 and 2, but directly from the liquid nitrogen storage 9. The supply with the other lasing gases, namely CO₂ and helium, is carried out as before with the aid of cylinders 11 each containing these gases, or cylinders containing gaseous premixes, the composition of the final mixture depending on the laser used. The cylinders 11 are furthermore equipped with flow and/or pressure regulators, in particular tap valves with integrated expanders, and manometers, possibly as well as protective coverings used to protect said regulation members.

Consequently, according to the invention, the liquid nitrogen storage reservoir 9 makes it possible to supply not only the laser head 3 but also the oscillator 1, and optionally the optical path 2, with “bulk” nitrogen coming from said storage reservoir 9, which is drawn therefrom in liquid form and vaporized in the vaporizer 10, before being transported on the one hand to the laser head 3 via the line 8 which branches, and on the other hand to the laser oscillator 1 via an additional line 18 which is connected to the line 8, that is to say a branch of the line 8.

Optionally, some of the nitrogen may also be transported in the optical path 2 which is used to recover the laser beam at the output of the laser generator 1, then transport it as far as the laser head 3 comprising a laser nozzle and a focusing device 4, such as a lens or a focusing mirror. The laser beam therefore passes through the laser head 3 while being focused therein, before striking the part or parts 6 to be welded or cut, for example, the head 3 furthermore being supplied with nitrogen coming from the reservoir 9.

The optical path 2 is typically formed by a passage provided with optical elements, such as mirrors and/or lenses.

The gas source or reservoir line is preferably a storage reservoir of large capacity, that is to say having a capacity of at least 900 liters, preferably at least 3000 liters of nitrogen.

Typically, this reservoir 1 is located outside the building in which the rest of the equipment is installed, i.e. principally the laser generator 1, the optical path 2 and the laser head 3, as well as the support table 7 on which the part or parts 6 to be machined rest, and the protective enclosure 15.

This is because it is then easier to fill the large-capacity reservoir 9 when it is empty or nearly empty, either by filling the reservoir 9 with nitrogen brought on site by a tanker, or by replacing the empty reservoir 1 with another full reservoir, in particular if the reservoir is a mobile reservoir of the “ranger” type.

Given that the working pressures of the gas inside the optical path 2, the laser head 3 and the laser oscillator 1 are generally different, it is preferable to provide one or more gas expansion devices 20, such as gas expanders, along the main pipe 8 and/or along the secondary pipe 18.

An expansion device 20 should be designed for and capable of reducing the pressure of the gas flowing in the main pipe 8 or secondary pipe 18, before it is introduced into the optical path 2, the head 3 or the oscillator 1.

Typically, the gas conveyed by the main pipe 8 is at a pressure of between 15 and 32 bar relative, for example of the order of 25 bar, while in the optical path, the gas is in overpressure in order to prevent the particles in the air from entering. The supply of the laser oscillator has a relative pressure of between 1 and 15 bar.

Furthermore, FIG. 4 is similar to FIG. 3 except for the fact that the equipment also comprises a purification device 21, such as a filter, arranged along the secondary pipe 18, preferably between the expander 20 and the inlet of the oscillator 1, so as to be able to ensure a given high purity of the lasing gas, namely nitrogen, introduced into the oscillator 1.

1-15. (canceled)

16. Laser machining equipment, comprising:
a laser oscillator for generating a laser beam,
a laser head through which the laser beam passes,
an optical path for transporting the laser beam between the laser oscillator and the laser head,
a gas source fluidically connected to the laser head by means of a main gas pipe, and
a secondary pipe fluidically connecting said gas source to the laser oscillator.

17. The equipment of claim 16, wherein the gas source is a storage reservoir having a capacity of at least 900 liters

18. The equipment of claim 16, wherein the gas source is a storage reservoir having a capacity of at least 3000 liters.

19. The equipment of claim 16, wherein further comprising a gas expansion device which is arranged along the secondary pipe and makes it possible to reduce the pressure of the gas coming from the gas source before said gas is introduced into the oscillator.

20. The equipment of claim 16, wherein the gas source is a liquid nitrogen storage reservoir.

21. The equipment of claim 16, wherein the gas source is fluidically connected to the laser head and to the optical path by means of the main pipe.

22. The equipment of claim 16, further comprising a gas vaporizer arranged between the gas source and the main pipe or the secondary pipe and/or a gas purification device which comprises a filter or an adsorbent which is capable of and designed for removing at least one impurity selected from among water vapor, hydrocarbons and oxygen.

23. The equipment of claim 16, wherein the oscillator is furthermore supplied with at least CO₂ and helium or a CO₂/He mixture coming from one or more gas cylinders.

24. The equipment of claim 16, wherein the laser oscillator is of the CO₂ type.

25. The equipment of claim 16, wherein the laser oscillator, the optical path and the laser head are located inside a building, and the gas source is located outside said building.

26. The equipment of claim 25, wherein the cylinders are inside the building.

27. A method for supplying laser machining equipment, comprising a laser oscillator, a laser head, and an optical path for transporting the laser beam between the laser oscillator and the laser head, with a gas coming from a gas source, in which:
a) some of the gas coming from the gas source is conveyed in a main pipe connecting said gas source to said laser head and in a secondary pipe connecting the gas source to the oscillator, and
b) said laser head is supplied with gas coming from said main pipe,
wherein the oscillator is supplied with gas coming from said secondary pipe.

28. The method of claim 27, wherein the gas from the main pipe is introduced into the optical path.

29. The method of claim 27, wherein the gas is nitrogen.

30. The method of claim 27, wherein the pressure of the gas is adjusted before it is introduced into the optical path, the oscillator and/or the laser head.

31. The method of claim 27, wherein the gas source is a storage reservoir having a capacity of at least 900 liters.

32. The method of claim 31, wherein the gas source is a storage reservoir having a capacity of at least 3000 liters.

33. The method of claim 27, wherein the oscillator is furthermore supplied with oxygen and CO₂ or a CO₂/He mixture coming from one or more gas cylinders.
